(19) United States
(12) Patent Application Publication
(10) Pub. No.: US 2025/0356624 A1
(43) Pub. Date: Nov. 20, 2025

(54) CAMERA ASSISTED LIDAR DATA VERIFICATION

(71) Applicant: MOTIONAL AD LLC, Boston, MA (US)

(72) Inventors: Lin Luo, Boston, MA (US); Ting Wang, Boston, MA (US); Geng Fu, Boston, MA (US)

(21) Appl. No.: 19/120,425

(22) PCT Filed: Oct. 2, 2023
(86) PCT No.: PCT/US2023/034305

§ 371 Date: Apr. 11, 2025

Related U.S. Application Data
(60) Provisional application No. 63/416,487, filed on Oct. 14, 2022.

(51) Int. Cl. G06V 10/764; B60W 30/09; G06V 10/25; G06V 10/26; G06V 10/56; G06V 10/60; G06V 10/82; G06V 20/58; G06V 40/10

(52) U.S. Cl. CPC G06V 10/764; B60W 30/09; G06V 10/25; G06V 10/26; G06V 10/56; G06V 10/60; G06V 10/82; G06V 20/58; B60W 2420/403; B60W 2420/408; B60W 2554/4029; B60W 2556/40; G06V 40/10; G06V 2201/08

(57) ABSTRACT

Provided are methods for camera-assisted LiDAR data verification. A vehicle (such as an autonomous vehicle) has multiple sensors mounted at various locations on the vehicle. Data from these sensors can be used for object detection. In object detection, sensor data is analyzed to annotate portions of the sensor data with confidence scores that indicate the presence of a particular object class instance within a respective portion of the data captured by a sensor. Systems and computer program products are also provided.

### CROSS-REFERENCE TO RELATED APPLICATIONS

The present application claims priority to U.S. Patent Application No. 63,416/487, filed on Oct. 14, 2022, entitled “Camera-Assisted LiDAR Data Verification for Self-Driving Vehicles,” which is herein incorporated by reference in its entirety.

### BACKGROUND

Autonomous vehicles use sensor data for object detection. In object detection, the sensor data is analyzed to determine the presence of object class instances. Autonomous vehicles navigate through an environment according to the detected objects. For example, the autonomous vehicle generates routes to avoid conflicts with the detected objects.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIG. 5 shows a diagram of an implementation of camera assisted LiDAR data verification;

FIG. 6A shows the impact of ambient lighting on the LiDAR sensors and cameras of a vehicle;

FIG. 6B shows the impact of objects of different colors on the LiDAR sensors and cameras of a vehicle;

FIG. 6C shows the impact of an object with different attributes on the LiDAR sensors and camera of a vehicle;

FIG. 7 shows a workflow for camera assisted LiDAR data verification;

FIG. 8 shows an application of the camera assisted LiDAR data verification;

FIG. 9 is a flow chart for a process that enables camera assisted LiDAR data verification;

FIG. 10 shows a bird's eye view of LiDAR sensors emitting light reflected at varying angles of detection;

FIG. 11 shows a workflow for camera assisted LiDAR data verification;

FIG. 12 shows a flowchart of a process for camera assisted LiDAR data verification; and

FIG. 13 shows a flowchart of a process for LiDAR semantic network confidence score based on angle information.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

### General Overview

In some aspects and/or embodiments, systems, methods, and computer program products described herein include and/or implement camera-assisted LiDAR data verification. A vehicle (such as an autonomous vehicle) has multiple sensors mounted at various locations on the vehicle. Data from these sensors can be used for object detection. In object detection, sensor data is analyzed to annotate portions of the sensor data with confidence scores that indicate the presence of a particular object class instance within a respective portion of the data captured by a sensor. In some embodiments, a first semantic segmentation network (e.g., LiDAR semantic network) and a second semantic segmentation network (e.g., image semantic network) execute with sensor data as inputs. A difference between a first location (e.g., 3D location from LiDAR) output by the first semantic segmentation network and a second location (e.g., 2D location from camera) output by the second semantic segmentation network is determined. A first confidence score (e.g., LiDAR confidence data) output by the first semantic segmentation network is updated based on a second confidence score (e.g., camera confidence data) output by the second semantic segmentation network when the difference between the first location and the second location satisfies a first predetermined threshold (e.g., threshold of distance) In examples, the output of the first semantic segmentation network including the updated first confidence score and the output of the second semantic segmentation network is concatenated and used to detect an object.

In some embodiments, a first semantic segmentation network (e.g., image semantic network) obtains camera data as input and outputs a first object spatial information of an object, an object attribute information of the object, an object color information of the object, and a first detection confidence score associated with the object. Angle information (e.g., the angle of a detected surface of the object with respect to the vehicle) is determined based on the first object spatial information. A second semantic segmentation network (e.g., LiDAR semantic network) obtains as input second sensor data (e.g., LiDAR data, point cloud data), the angle information, the object attribute information, the object color information, and the first detection confidence score, and outputs a second object spatial location and a second detection confidence score. In examples, the output of the second semantic segmentation network is used for object detection.

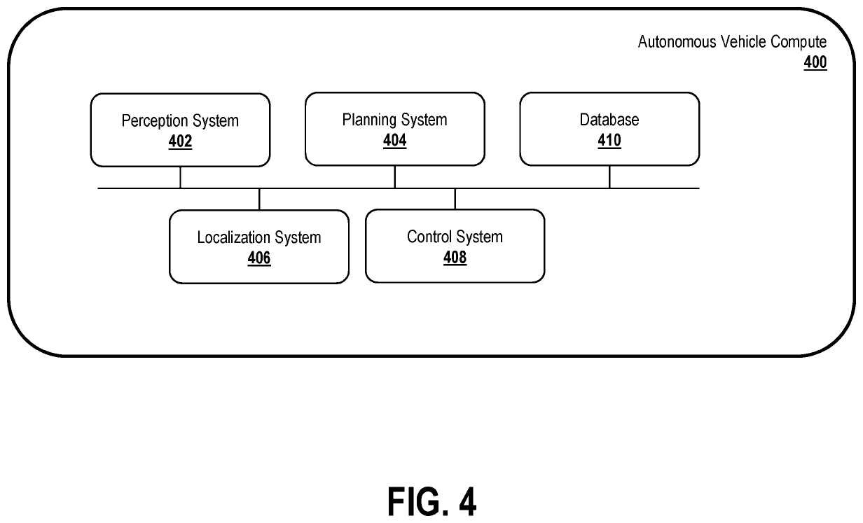

By virtue of the implementation of systems, methods, and computer program products described herein, techniques for camera-assisted LiDAR data verification enable an increased accuracy of data output by a LIDAR semantic network. In turn, the resulting object detection is more accurate when compared to object detection without LiDAR data verification. The present techniques increase the accuracy of confidence scores output by the LiDAR semantic network using existing output by an image semantic network, in real time. The increase in accuracy of the confidence scores results in improved downstream performance of an autonomous vehicle (AV) stack, such as the AV stack of FIG. 4. In particular, the performance of AV systems such as a perception system, planning system, localization system, and/or control system is improved based on the use of accurate confidence scores output by the LiDAR semantic network.

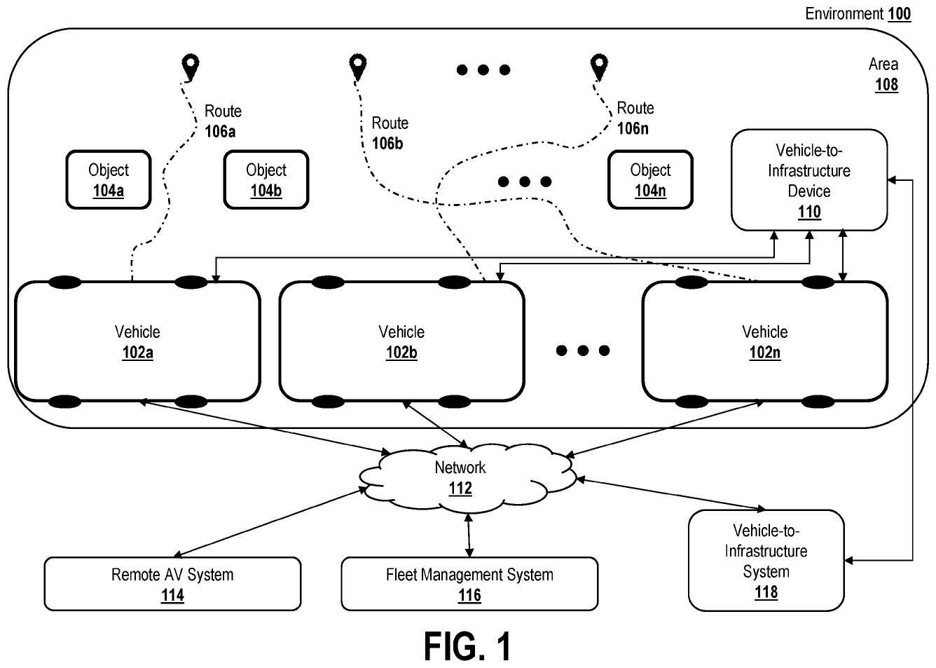

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

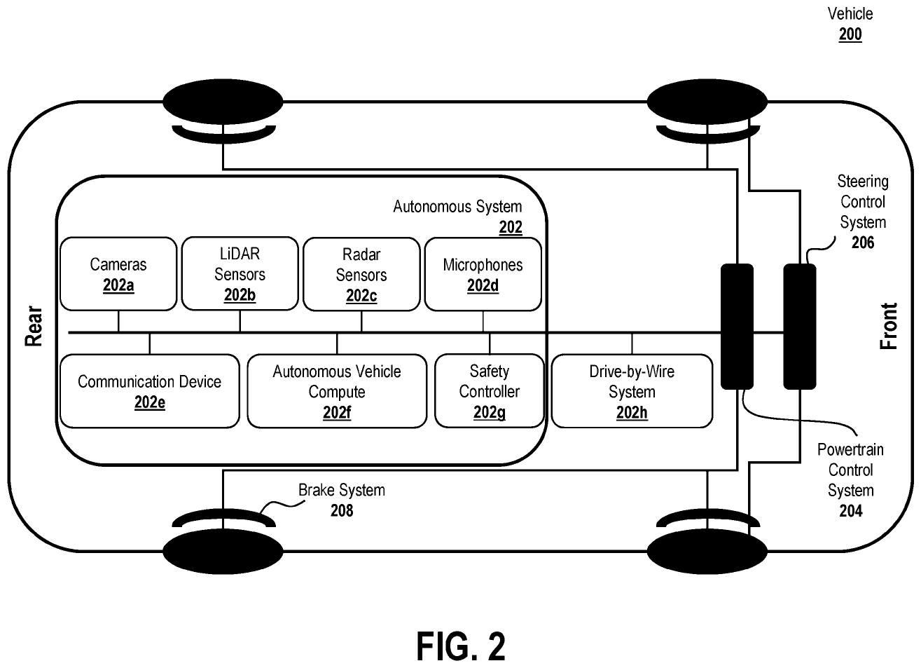

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure or Vehicle-to-Everything (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 (which may be the same as, or similar to vehicles 102 of FIG. 1) includes or is associated with autonomous system 202, powertrain control system 204, steering control system 206, and brake system 208. In some embodiments, vehicle 200 is the same as or similar to vehicle 102 (see FIG. 1). In some embodiments, autonomous system 202 is configured to confer vehicle 200 autonomous driving capability (e.g., implement at least one driving automation or maneuver-based function, feature, device, and/or the like that enable vehicle 200 to be partially or fully operated without human intervention including, without limitation, fully autonomous vehicles (e.g., vehicles that forego reliance on human intervention such as Level 5 ADS-operated vehicles), highly autonomous vehicles (e.g., vehicles that forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 202 includes operational or tactical functionality required to operate vehicle 200 in on-road traffic and perform part or all of Dynamic Driving Task (DDT) on a sustained basis. In another embodiment, autonomous system 202 includes an Advanced Driver Assistance System (ADAS) that includes driver support features. Autonomous system 202 supports various levels of driving automation, ranging from no driving automation (e.g., Level 0) to full driving automation (e.g., Level 5). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, drive-by-wire (DBW) system 202h, and safety controller 202g.

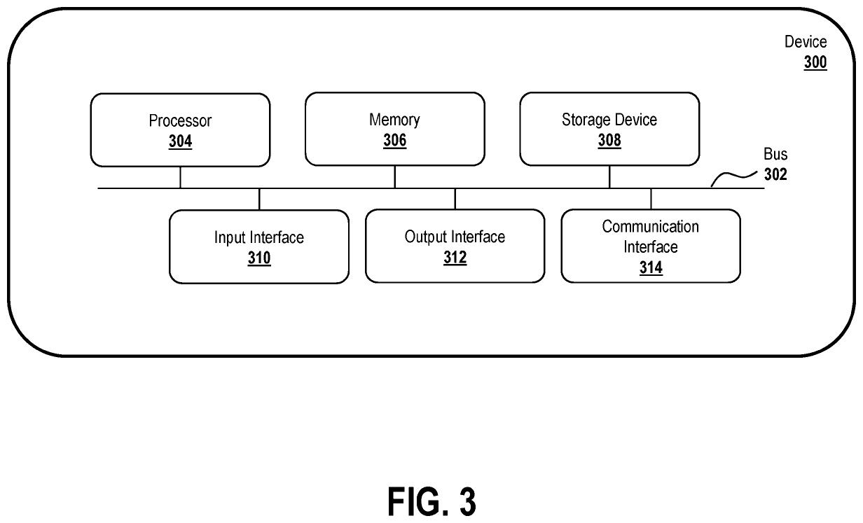

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a Charge-Coupled Device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD (Traffic Light Detection) data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum. In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e includes at least one device configured to be in communication with cameras 202a, LiDAR sensors 202b, radar sensors 202c, microphones 202d, autonomous vehicle compute 202f, safety controller 202g, and/or DBW (Drive-By-Wire) system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. In other words, steering control system 206 causes activities necessary for the regulation of the y-axis component of vehicle motion.

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 208 is illustrated to be located in the near side of vehicle 200 in FIG. 2, brake system 208 may be located anywhere in vehicle 200.

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102), at least one device of cameras 202a (e.g., at least one device of a system of cameras 202a), at least one device of LiDAR sensors 202b (e.g., at least one device of a system of LiDAR sensors 202b), and/or one or more devices of network 112 (e.g., one or more devices of a system of network 112). In some embodiments, one or more devices of vehicles 102 (e.g., one or more devices of a system of vehicles 102), one or more devices of cameras 202a (e.g., one or more devices of a system of cameras 202a), one or more devices of LiDAR sensors 202b (e.g., one or more devices of a system of LiDAR sensors 202b), and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some cases, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 300 performs one or more processes described herein. Device 300 performs these processes based on processor 304 executing software instructions stored by a computer-readable medium, such as memory 305 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “module” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a module is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception module), planning system 404 (sometimes referred to as a planning module), localization system 406 (sometimes referred to as a localization module), control system 408 (sometimes referred to as a control module), and database 410. In some embodiments, perception system 402, planning system 404, localization system 406, control system 408, and database 410 are included and/or implemented in an autonomous navigation system of a vehicle (e.g., autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In other words, planning system 404 may perform tactical function-related tasks that are required to operate vehicle 102 in on-road traffic. Tactical efforts involve maneuvering the vehicle in traffic during a trip, including but not limited to deciding whether and when to overtake another vehicle, change lanes, or selecting an appropriate speed, acceleration, deceleration, etc. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. For example, control system 408 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like).

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

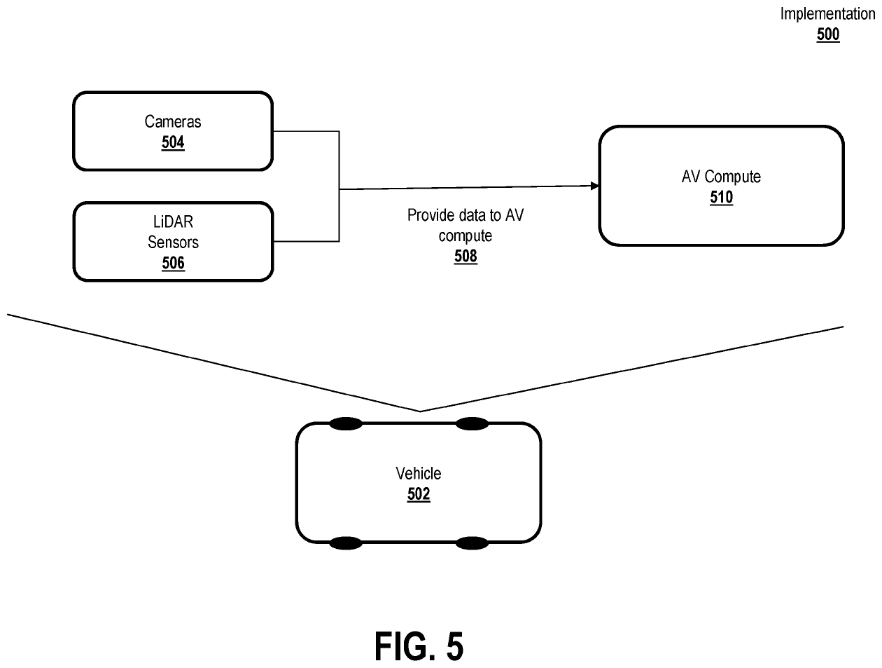

Referring now to FIG. 5, illustrated is a diagram of an implementation 500 of camera assisted LiDAR data verification at the vehicle 502. In some embodiments, implementation 500 includes cameras 504, LiDAR sensors 506, and an AV compute 510. In some embodiments, cameras 504, LiDAR sensors 506, and AV compute 510 are the same as or similar to cameras 202a, LiDAR sensors 202b, and an AV compute 202f of system 202 as shown in FIG. 2, respectively.

In the example of FIG. 5, the cameras 504 generate camera data that forms an image of the environment. In some embodiments, the image is a two-dimensional (2D) representation of the environment. The image includes a number of pixels that specify color and intensity at each pixel of the image. In examples, a color is represented by component intensities such as red, green, and blue, or cyan, yellow, and white. The LIDAR sensors 506 include an emitter and receiver. The emitter emits light into the environment that is reflected by objects in the environment. The receiver captures light that is reflected by the objects in the environment, and the captured reflected light (e.g., LiDAR data) is used to generate a point cloud. In examples, the point cloud is a discrete set of three-dimensional (3D) data points in the environment. The cameras 504 and the LIDAR sensors 506 capture data within a respective field of view (FOV). The respective FOVs overlap, such that data 2D image data and 3D point cloud data is captured for the same locations in the environment.

The images created from camera data as captured by the cameras 504 and the point clouds created from LiDAR data captured by the LiDAR sensors 506 are used to detect and classify features of the environment. Accordingly, the output of the cameras 504 and LiDAR sensors 506 is provided to the AV compute 510 for further processing, such as object detection and classification. In examples, camera data provides accurate measurements of edges, color, and lighting, which ultimately yields accurate object classification in the resulting image. The LiDAR data typically contains less semantic information when compared to image data from the cameras 504, and instead enables highly accurate 3D localization. In some examples, the LiDAR data is sparse due to low reflectance from the objects in the environment. Low reflectance corresponds to a low confidence in the LiDAR data, which negatively impacts AV functionality based on LiDAR data such as perception and localization. Confidence in LiDAR data is affected by several factors, such as lighting, object color, and object material type. The present techniques use camera data corresponding to LiDAR data to determine a confidence associated with the LiDAR data. In examples, lighting, object color, and object material type are analyzed using camera data, and a confidence in the corresponding LiDAR data is updated based on the analysis. For example, when camera data such as lighting, object color, and object material type indicates a low reflectance, the confidence score associated with the LiDAR data is updated based on the confidence score associated with the camera data.

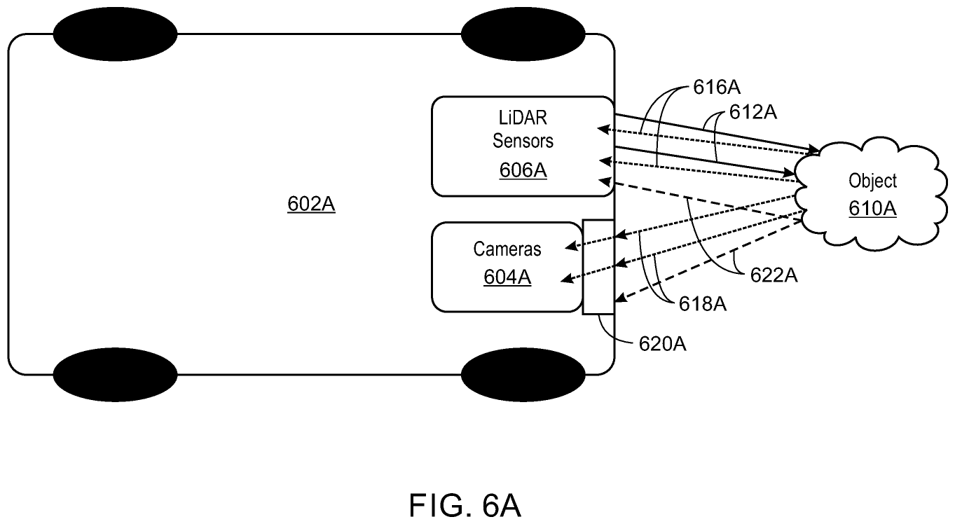

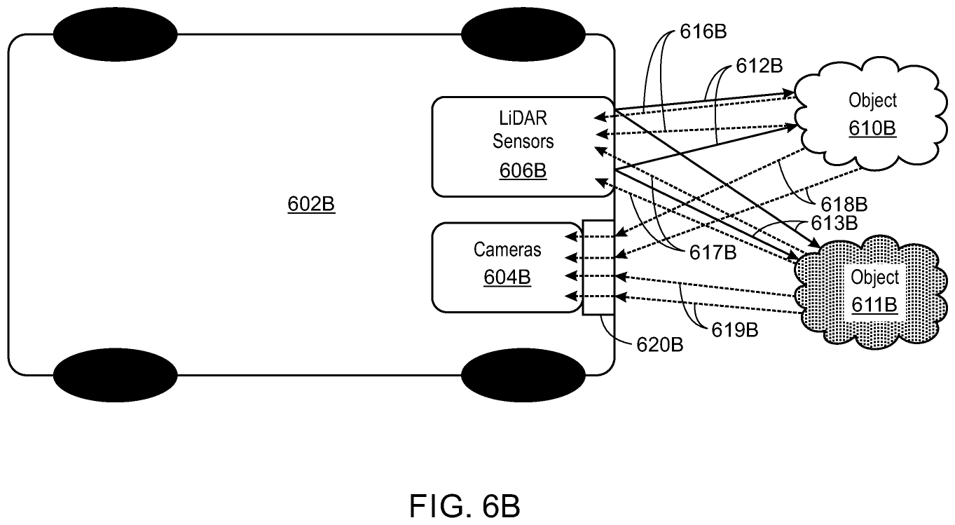

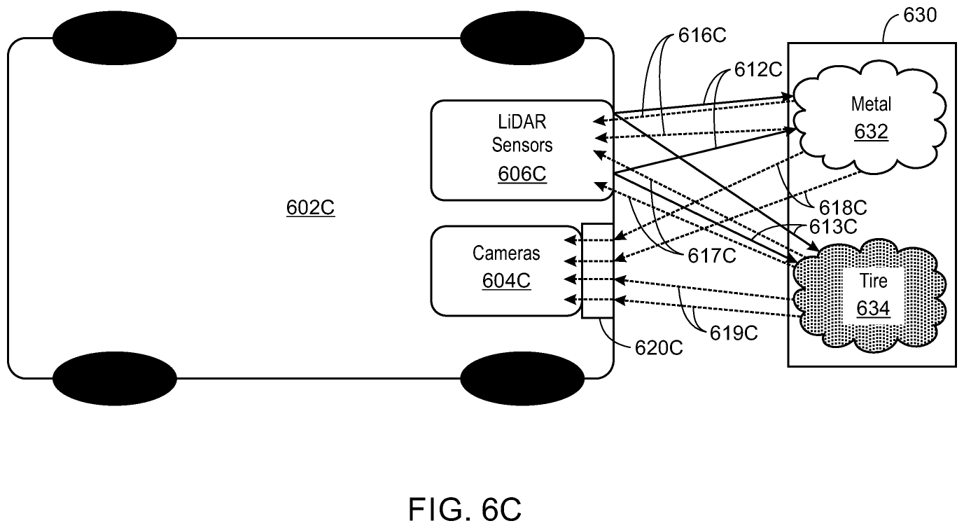

FIG. 6A shows the impact of ambient lighting on the LiDAR sensors and cameras of a vehicle. A vehicle 602A includes cameras 604A and LiDAR sensors 606A. In examples, the cameras 604A are the same as or similar to cameras 504 of FIG. 5, and the LiDAR sensors 606A are the same as or similar to LiDAR sensors 506 of FIG. 5. The cameras 604A and LiDAR sensors 606A capture data from the surrounding environment that enable detection of the object 610A. As shown, the LiDAR sensors 606A emit infrared light 612A that is reflected by the object and the reflected light 616A is captured by a receiver of the LiDAR 606A. Similarly, the camera 604A captures lighting 618A reflected by the object. Ambient lighting 622A in the environment is reflected from the object 610A. Ambient light 622A includes, for example, sunlight, moonlight, and other light sources such as traffic lights, lights from other buildings, and lights from vehicles. The ambient light 622A impacts the function of the LiDAR, as the LiDAR receiver captures the ambient light 622A along with the reflected light 616A. The camera includes an infrared (IR) filter 620A. The IR filter 620A can filter the ambient lighting 622A from the other lighting 618A reflected by the object. As a result, the ambient lighting does not corrupt the camera data. However, the ambient lighting can cause noise or other artifacts in the LiDAR data.

FIG. 6B shows the impact of objects of different colors on the LiDAR sensors and cameras of a vehicle. In examples, the cameras 604B are the same as or similar to cameras 504 of FIG. 5, and the LiDAR sensors 606B are the same as or similar to LiDAR sensors 506 of FIG. 5. In the example of FIG. 6B, object 610B is a light colored object, such as white. Object 611B is a dark colored object, such as black. Different colors are associated with varying light reflectance values. For example, on a scale from 0% to 100%, a reflectance value of 0% corresponds to pure black with little to no light reflected by the pure black surface. A reflectance value of 100% corresponds to pure white, with the most or all light reflected by the pure white surface. In examples, a reflectance value of less than 50% corresponds to a darker color that absorbs more light than it reflects. A reflectance value of greater than 50% corresponds to a lighter color that reflects more light than it absorbs. In the example of FIG. 6B, the LiDAR 606B emits infrared light 612B and 613B that is reflected by the light colored object 610B and dark colored object 611B, respectively. The reflected light 616B and reflected light 617B are captured by a receiver of the LiDAR 606B. Similarly, the camera 604A captures lighting 618B reflected by the light colored object 610B and lighting 619B reflected by the dark colored object 611B.

The dark colored object 611B reflects a smaller portion of light when compared to the light colored object 610B. Accordingly, the reflected light 617B is sparser than the reflected light 616B. The dark colored object 611B has a low reflectance, and there is a low confidence in the LiDAR data corresponding to the object 611B. Additionally, the low reflectance results in a lower detection rate associated with the dark colored object 611B based on the LiDAR data. In some examples, the data associated with the dark colored object 611B is erroneously classified as noise or an artifact, when an actual, real dark colored object is present. However, the cameras 604B are able to capture both the light colored object 610B and dark colored object 611B. In examples, the cameras 604B capture the dark colored object 611B with a higher confidence when compared to the confidence associated with the corresponding LiDAR data captured by the LiDAR sensors 606B.

FIG. 6C shows the impact of an object with different attributes on the LiDAR sensors and camera of a vehicle. In examples, the cameras 604C are the same as or similar to cameras 504 of FIG. 5, and the LiDAR sensors 606C are the same as or similar to LiDAR sensors 506 of FIG. 5. In the example of FIG. 6C, an object 630 includes a metal component 632 and a tire component 634. In examples, the object 630 is a bicycle. Different materials are associated with varying light reflectance values. For example, metals (e.g., stainless steel, aluminum, zinc, brass, galvanized steel, etc.), plastics (e.g., polyurethane, polypropylene, polyvinyl chloride, acrylonitrile butadiene styrene (ABS), polyamides (PA), polystyrene (PS), polyethylene (PE), polyoxymethylene (POM), polycarbonate (PC), acrylic (PMMA), etc.), wood, glass, and rubber are types of materials with differing reflectance values. Accordingly, the material type is an attribute of an object that impacts the reflectance of the object and subsequent detection by LiDAR sensors.

In the example of FIG. 6C, the LiDAR sensors 606C emit infrared light 612C and 613C that is reflected by the metal component 632 and tire component 634, respectively. The reflected light 616C and reflected light 617C are captured by a receiver of the LiDAR sensors 606C. Similarly, the cameras 604A capture lighting 618C reflected by the metal component 632 and lighting 619C reflected by the tire component 634. In examples, the LiDAR sensors 606C obtain more reflected light 616C from the metal component 632 when compared with reflected light 617C from the tire component 634. The camera 604C captures the entire object 630, and the resulting image data is used to detect both the metal component 632 and the tire component 634 of the object 630.

In the example of FIGS. 6A-6C, corresponding camera data and LiDAR data are used to update or generate a confidence score associated with the LiDAR data. In examples, lighting, object color, and object material type are analyzed from the camera data, and a confidence in the corresponding LiDAR data is updated or generated based on the analysis. In this manner, the camera data is used to verify the LiDAR data.

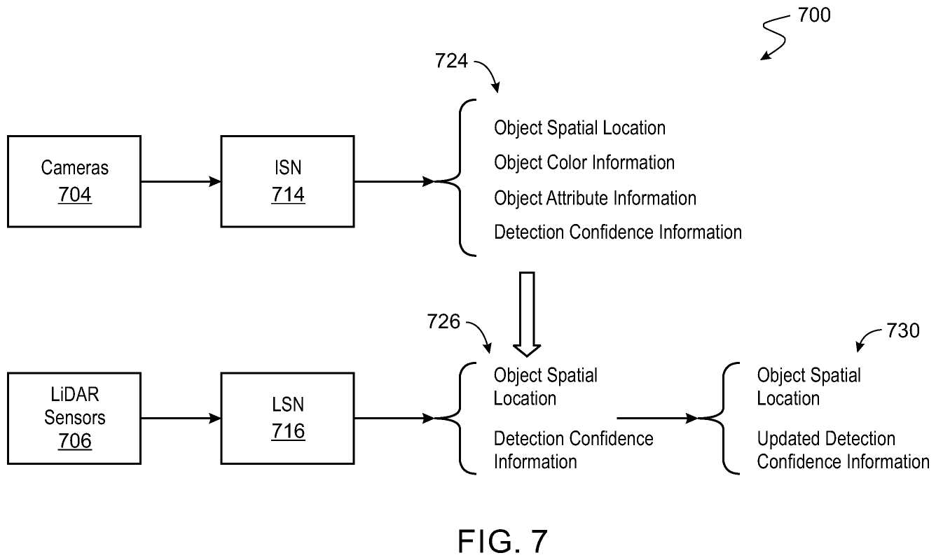

FIG. 7 shows a workflow 700 for camera assisted LiDAR data verification. In some embodiments, one or more of the steps described with respect to workflow 700 are performed (e.g., completely, partially, and/or the like) by autonomous vehicle (AV) system 114, fleet management system 116 described in FIG. 1, vehicle 200 of FIG. 2, device 300 of FIG. 3, autonomous vehicle compute 400 of FIG. 4, or the AV compute 510 of FIG. 5. In the example of FIG. 7, one or more camera(s) 704 and one or more LiDAR sensor(s) 706 are shown. In some embodiments, cameras 704 are the same as or similar to the cameras 202a of FIG. 2, the cameras 504 of FIG. 5, or cameras 604A-604C of FIGS. 6A-6C. In some embodiments, the LiDAR sensors 706 is the same as or similar to the LiDAR sensors 202b of FIG. 2, the LiDAR sensors 506 of FIG. 5, or LiDARs 606A-606C of FIGS. 6A-6C.

The workflow 700 includes two object detection networks, an image semantic segmentation network (ISN) 714 and a LiDAR semantic segmentation network (LSN) 716. Generally, an object detection neural network is configured to receive sensor data and process the sensor data to detect at least one object (e.g., objects 104 of FIG. 1, object 610A of FIG. 6A, objects 610B and 611B of FIG. 6B, object 630 of FIG. 6C) in the environment. In an embodiment, an object detection neural network is a feed-forward convolutional neural network that, given the sensor data (e.g., image data, LiDAR data, radar data, and/or the like), generates a set of bounding boxes for potential objects in the 3D space (e.g., environment) and confidence scores for the presence of object class instances (e.g., cars, pedestrians, or bikes) within the bounding boxes. The higher the classification score, the more likely the corresponding object class instance is present in a box.

The ISN 714 takes as input camera data from the cameras 704 and outputs a set of predicted 2D or 3D bounding boxes (e.g., object spatial information) for objects in the environment and corresponding confidence scores for the presence of object class instances within the bounding boxes. The ISN 714 also outputs color information and attribute information associated with a detected object. For example, the ISN 714 takes as input the camera data, predicts the class of each pixel in the camera data and outputs semantic segmentation data (e.g., a confidence score) for each pixel in the image. For example, each pixel is associated with 2D spatial coordinates (e.g., x, y coordinates). The ISN 714 is trained using an image dataset that includes images augmented with bounding boxes and segmentation labels for classes in the image dataset. In examples, a confidence score is a probability value that indicates the probability that the class of the pixel was correctly predicted. Similarly, the LSN 716 takes as input LiDAR data and outputs a set of predicted 3D bounding boxes for potential objects in the 3D space and confidence scores for the presence of object class instances within the bounding boxes. In an example, the LSN receives a plurality of data points that represent the 3D space. For example, each data point of the plurality of data points is a set of 3D spatial coordinates (e.g., x, y, z coordinates). The predicted 3D set of bounding boxes (e.g., object spatial information) also include confidence scores for the presence of object class instances within the bounding boxes.

In the example of FIG. 7, the output 724 of the ISN 714 includes an object spatial location, object color information, object attribute information, and detection confidence score. The object spatial location provides location information and dimensions associated with an object. The location information represents a particular place or position of the object. The object color information refers to a particular color of the object. In examples, the object color information is specified according to color model values, such as an RGB color model, RYB color model, CMY color model, CMYK color model, or a cylindrical-coordinate color model. The object attribute information represents characteristics of the object, such as metal, plastic, rubber, wood, or other material types. The output 726 of the LSN 716 includes an object spatial location and detection confidence score.

Each of the ISN 714 and the LSN 716 output a respective detection confidence score based on data captured by the respective sensor. As described above, the detection confidence score can vary based on the data captured by the sensors. In some embodiments, the ISN detection confidence score is used to verify the LSN detection confidence. For example, the LSN detection confidence score is updated based on the ISN based detection confidence score when an analysis of the camera data determines that the object is associated with low reflectance values or that ambient lighting has corrupted the reflectance values as captured by the LiDAR.

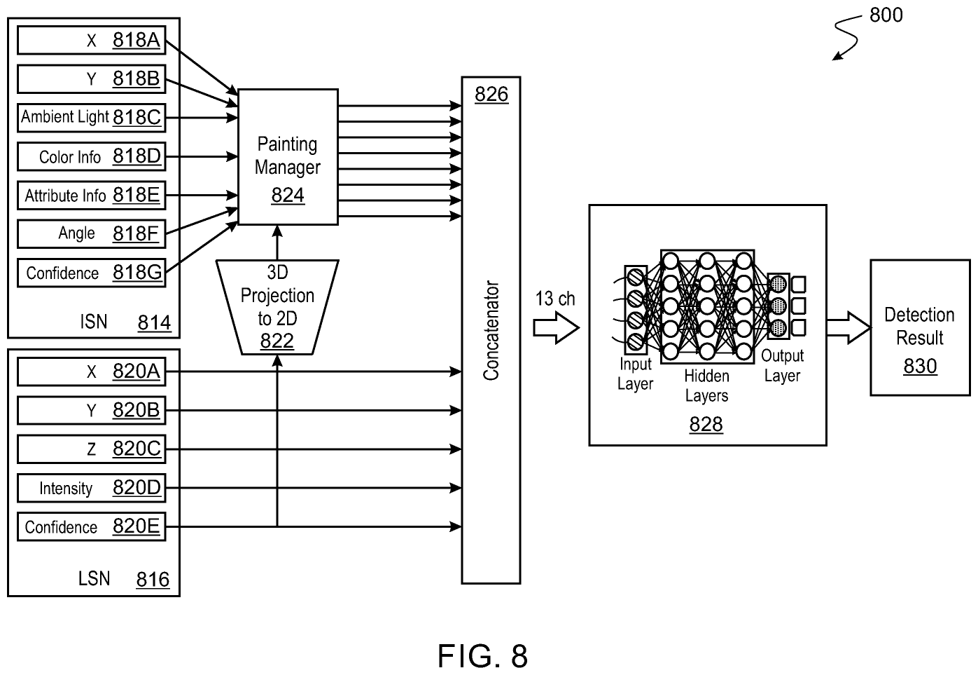

FIG. 8 shows an application of the camera assisted LiDAR data verification. In some embodiments, the ISN 814 is the same as or similar to the ISN 714 of FIG. 7; and the LSN 816 is the same as or similar to the LSN 716 of FIG. 7. The ISN 814 takes as input camera data and outputs a seven channel output including spatial coordinate x 818A, spatial coordinate y 818B, ambient light 818C, color information 818D, attribute information 818E, angle of detection 818F, and confidence score 818G (collectively referred to as output 818). The LSN 816 takes as input LiDAR data and outputs a five channel output including spatial coordinate x 820A, spatial coordinate y 820B, spatial coordinate z 820C, intensity 820D, and confidence 820E (collectively referred to as output 820).

The output 820 of the LSN 816 is projected onto a 2D plane by the 3D to 2D projection 822. The output 820 of the LSN is projected onto respective pixels arranged in a 2D plane. As shown in FIG. 8, the LSN 816 outputs 3D spatial information (x, y, and z), while the ISN outputs 2D spatial information (x, y). The projection 822 transforms the LSN spatial information to a 2D format. A painting manager 824 associates the data form the ISN 814 and projected data from the LSN 816 with pixels on a 2D plane to generate painted pixels. The painted pixels have additional context that enables the generation of labels for the objects with improved accuracy.

As shown in FIG. 8, the painting manager 824 outputs the painted pixels. A concatenator 826 obtains the painted pixels and output 820 of the LSN 816 and concatenates corresponding points (e.g., points that include information associated with a same or approximately same real-world location). In examples, the concatenator combines the painted pixels and LiDAR output. The painted pixels output by the painting manager include color and attribute information, which is missing in the LiDAR output 820. The spatial location information associated with the painted pixels is 2D spatial information (e.g., spatial coordinate x 818A and spatial coordinate y 818B). However, the LiDAR output 820 includes 3D spatial information (e.g., spatial coordinate x 820A, spatial coordinate y 820B, spatial coordinate z 820C). The painted pixels and output 820 are concatenated and input into the neural network, and the input to the neural network includes 2D and 3D spatial information. In examples, the concatenated information is input to neural network such as an object detection network. In some embodiments, the object detection network is an enhanced bird's eye view network (BEVN) 828. The BEVN 828 obtains the thirteen channel output from the concatenator 826 and outputs an object detection result 830. In examples, the object detection result 830 includes spatial information associated with the object (x, y, z, and size) and a classification result.

In some embodiments, the BEVN 828 is trained to determine learn from the differences in confidences between the ISN 814 and LSN 816. For example, the confidence 818G associated with the camera data and the confidence 820E associated with the LiDAR data is input to the BEVN 826, which learns from the confidences to output detection results 830.

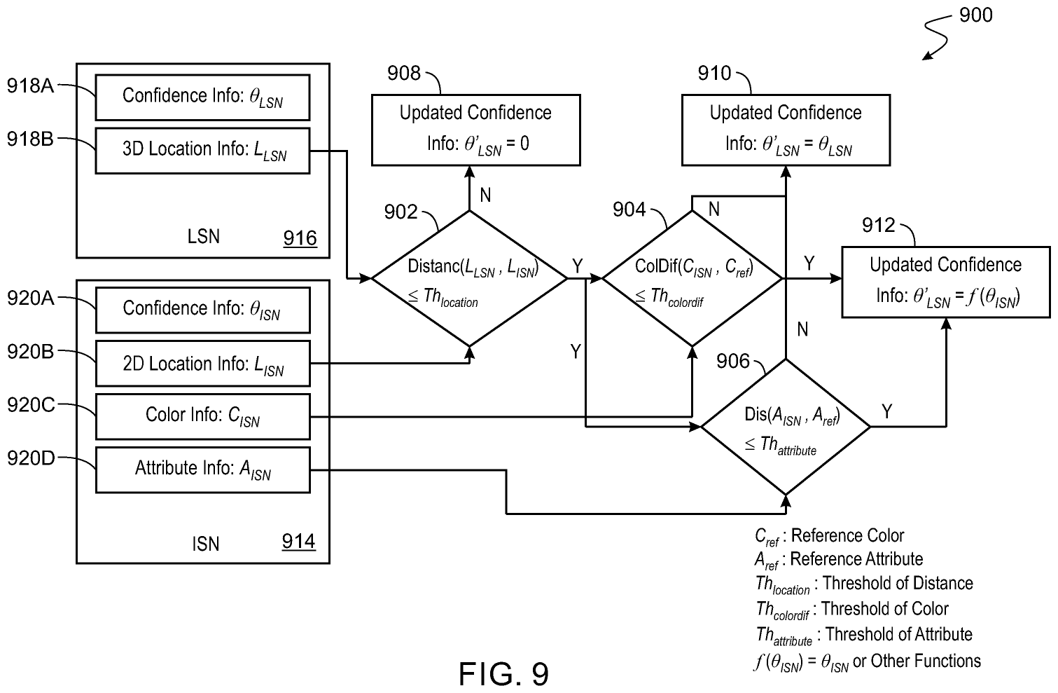

FIG. 9 is a flow chart for a process that enables camera assisted LiDAR data verification. In some embodiments, one or more of the steps described with respect to the process 900 are performed (e.g., completely, partially, and/or the like) autonomous vehicle (AV) system 114, fleet management system 116 described in FIG. 1, vehicle 200 of FIG. 2, device 300 of FIG. 3, autonomous vehicle compute 400 of FIG. 4, or the AV compute 510 of FIG. 5. In some embodiments, the ISN 914 is the same as or similar to the ISN 814 of FIG. 8 or the ISN 714 of FIG. 7; and the LSN 916 is the same as or similar to the LSN 816 of FIG. 8 of the LSN 716 of FIG. 7.

In the example of FIG. 9, a series of decisions 902, 904, and 906 is used to analyze the camera data and determine if the corresponding LSN confidence score θ_{LSN}associated with LiDAR data is updated (θ′_{LSN}) based on the ISN confidence score θ_{ISN}. At decision block 902, a distance between LSN location information L_{LSN} 918B and ISN location information L_{ISN} 920B is determined. In examples, the LSN location information L_{LSN} 918B is the 3D spatial information (e.g., spatial coordinate x 820A, spatial coordinate y 820B, spatial coordinate z 820C) described with respect to FIG. 8. Additionally, in examples the ISN location information L_{ISN} 920B is the 2D spatial information (e.g., spatial coordinate x 818A and spatial coordinate y 818B) described with respect to FIG. 8. The LSN location information L_{LSN} 918B is projected onto a 2D plane (e.g., projection 822 of FIG. 8). The difference between the projected LSN location information L_{LSN} 918B and ISN location information L_{ISN} 920B is compared at decision block 902.

If a difference between the LSN location information L_{LSN} 918B and ISN location information L_{ISN} 920B satisfies a threshold of distance Th_{location}, a second decision block 904 is evaluated. If the difference between the LSN location information L_{LSN} 918B and ISN location information L_{ISN} 920B does not satisfy a threshold of distance Th_{location}, the updated LSN confidence score θ′_{LSN} is set to zero at block 908. For example, the difference between the LSN location information L_{LSN} 918B and ISN location information L_{ISN} 920B satisfies a threshold of distance Th_{location} when the difference is less than the threshold of distance Th_{location}. The distance between the L_{SN} location information L_{LSN} 918B and ISN location information L_{ISN} 920B is evaluated to ensure that the camera data and LiDAR data are based on a same object or a same location in the environment. If the distance between the LSN location information L_{LSN} 918B and ISN location information L_{ISN} 920B exceeds the threshold of distance Th_{location}, the camera data and LiDAR data can represent different objects. Accordingly, the LSN confidence score θ_{LSN} is not updated based on the ISN confidence score θ_{ISN} when the distance between the LSN location information L_{LSN} 918B and ISN location information L_{ISN} 920B exceeds the threshold of distance Th_{location}. In examples, the threshold is a number of pixels in 2D camera coordinates, such as 5 pixels, 10 pixels, etc. The threshold is determined during, for example, camera-LiDAR calibration.

At the decision block 904, color information C_{ISN} 920C output by the ISN 914 is evaluated. If the difference in color information C_{ISN} 920C and a reference color C_{ref} satisfies a threshold of color, TH_{colordif}, the LSN confidence score θ′_{LSN} is updated according to the ISN confidence score θ_{ISN} at block 912. In examples, the LSN confidence score θ′_{LSN} is updated as a function of the ISN confidence score, f(θ_{LSN}). If the difference in color information C_{ISN} 920C and a reference color C_{ref} does not satisfy a threshold of color, TH_{colordif}, the updated LSN confidence score θ′_{LSN} is set to the LSN confidence score θ_{LSN} 918A as determined by the LSN 916 at block 910. In examples, the difference between the color information C_{ISN} 920C and a reference color C_{ref} satisfies the threshold of color TH_{colordif} when the difference is less than the threshold of color TH_{colordif}. In examples, the reference color is a predetermined color that is known to have low reflectance values as detected by the LiDAR. In some examples, the reference color is a dark color with a reflectance value of less than 50%. If the color information C_{ISN} 920C as determined by the ISN is close to (within a threshold) of the reference color, it is a similarly dark color that causes sparse LiDAR detections with a low confidence in such detections. Accordingly, LSN confidence score θ′_{LSN} is updated for known problematic colors within the threshold of color Th_{colordif} with respect to the reference color C_{ref} at block 912.

At decision block 906, attribute information A_{ISN} 920D output by the LSN is evaluated. If the difference in attribute information A_{ISN} 920D and a reference attribute A_{ref} satisfies a threshold of attribute, TH_{attribute}, the LSN confidence score θ′_{LSN} is updated according to the ISN confidence score θ_{ISN} at block 912. If the difference in attribute information A_{ISN} 920D and a reference attribute A_{ref} does not satisfy than a threshold of attribute, TH_{attribute}, the LSN confidence score θ′_{LSN} is set to the LSN confidence score θ_{LSN} 918A as determined by the LSN 916 at block 910. In examples, the difference between attribute information A_{ISN} 920D and the reference attribute A_{ref} satisfies the threshold of attribute TH_{attribute} when the difference is less than the threshold of attribute, TH_{attribute}. Additionally, in examples, the reference attribute A_{ref} is one or more material types that are known to have low reflectance values. In some examples, the reference attribute is plastic, rubber, wood, and the like. In examples, an attribute such as plastic has a weak reflectance, while an attribute such as metal is a strong reflectance. If the attribute information A_{ISN} 920D as determined by the ISN is close to (within a threshold) of the reference attribute, it is a similar attribute type that causes sparse LiDAR detections with a low confidence in such detections. Accordingly, LSN confidence score θ′_{LSN} is updated for known problematic attributes within the threshold of attribute Th_{attribute} with respect to the reference attribute A_{ref} 920D at block 912.

In the example of FIG. 9, location information from both the LSN and ISN is used to ensure that a same object is being compared between the LSN and ISN data. Once the same object is being compared, features of the ISN data are evaluated to determine if the corresponding LiDAR data is subject to noise or low confidences. If the features indicate the presence of known negative impacts on LiDAR detections, the LIDAR confidence score is updated according to the ISN confidence score.

In examples, black objects or substantially black objects are processed differently due to low reflectance. In examples, there are holes in point cloud data when a LiDAR is used to detect black objects, such as black vehicles, pedestrians wearing black clothes, bicycles, and so on. For example, for black vehicles holes exist in point cloud data for the black car body however in some instances the reflective car windows are accurately represented in the point cloud. In examples, pedestrians wearing black clothes create holes in point cloud data where the dark colored clothing is located, however in some instances visible skin of the pedestrian is accurately represented in the point cloud. In examples, for bicycles, holes exist in the point cloud data reflected by bike tires, but a non-black bicycle frame is accurately represented in the point cloud data. In some embodiments, the image-based neural network detection results and camera/vehicle calibration data are used to assist LiDAR detection. The LiDAR semantic network receives object color information, object angle information related to the AV, and vehicle model information (when applicable) as input, and outputs a more robust spatial location and confidence score. Accordingly, in some embodiments the data output by an ISN is used to assess LiDAR detection of objects with low or weak reflectance values.

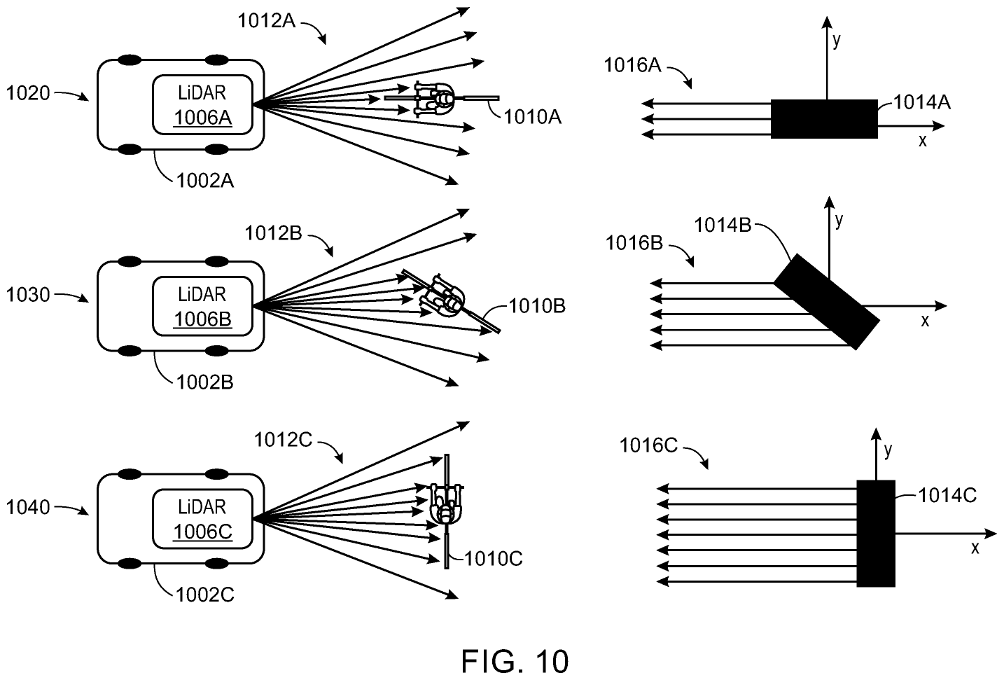

FIG. 10 shows a bird's eye view of LiDAR sensors emitting light reflected at varying angles of detection. Three examples 1020, 1030, and 1040 show LiDAR sensors 1006A, 1006B, and 1006C (collectively referred to as LiDARs 1006) of vehicles 1002A, 1002B, and 1002C (collectively referred to as vehicles 1006) emitting light 1012A, 1012B, and 1012C (collectively referred to as light 1012) onto respective objects 1010A, 1010B, and 1010C (collectively referred to as objects 1010). Angles of detection 1014A, 1014B, and 1014C (collectively referred to as angles of detection 1014) show varying reflected light 1016A, 1016B, and 1016C (collectively referred to as reflected light 1016).

In the example of FIG. 10, LiDARs 1006 emit light 1012 from a light emitter (e.g., a laser transmitter). Light emitted by a LiDAR system is typically not in the visible spectrum; for example, infrared light is often used. Some of the light 1012 emitted encounters physical objects 1010 (e.g., a cyclist) and reflects back to the LiDARs 1006. The LiDARs 1006 also include one or more receivers, which capture the reflected light 1016.

In examples, the LiDAR sensors 1006 detect the boundary of the object 1010 based on characteristics of the reflected light 1016 captured by the LiDAR system 1002. As shown in example 1020, when an object 1010A is positioned with the narrowest view of the object substantially parallel to light 1012A emitted from the LiDAR sensor 1006A, a small amount of reflected light 1016A is obtained by the LiDAR sensor 1006A. Put another way, because the object 1010A is oriented with its narrowest view perpendicular to a line of sight of the LIDAR (corresponding to light 1012A), the smallest surface of the object is oriented to reflect light 1016A to the LiDAR sensor 1006A, resulting in a minimum amount of captured data at the LiDAR sensor 1006A.

In example 1030, the object is positioned such that the narrowest portion of the object in the X-Y plane is rotated so that the narrowest portion is not substantially perpendicular to light 1012B emitted from the LiDAR sensor 1006B, where the light 1012B corresponds to a line of sight of the LiDAR. A greater amount of reflected light 1016B is obtained by the LiDAR sensor 1006B when compared to the reflected light 1016A captured by LiDAR sensor 1006A. Because the object 1010A is oriented with the narrowest portion angled away from the LiDAR line of sight, additional surface area of the object is oriented to reflect light 1016B to the LiDAR sensor 1006B. This results in an additional amount of captured data at the LiDAR sensor 1006B when compared with the captured data at the LiDAR sensor 1006C.

In example 1040, when an object is positioned with the widest view of the object substantially perpendicular to light 1012C emitted from the LiDAR sensor 1006C, the greatest amount of reflected light 1016C is obtained by the LiDAR sensor 1006C. Because the object 1010C is oriented with its widest view in the line of sight of the LiDAR sensor 1006C, the greatest surface area of the object is oriented to reflect light 1016C to the LiDAR sensor 1006C, resulting in the maximum amount of captured data at the LiDAR sensor 1006C when compared to other orientations of the object.

In examples, when more of the surface area of the object is positioned to intersect the line of sight of the LiDAR, the strongest reflectance from the object is observed. In examples, as the detection angle of the object changes, so does the amount of reflectance from the object. In examples, the detection angle can be calculated from object spatial location from ISN, vehicle/map information, and camera calibration information. For example, known data points, object position, and calibration information are used to calculate the detection angle. In examples, the detection angle is determined using triangulation, multilateration, or localization. When the object is a dark color (e.g., a color with a reflectance value less than 50%), the angle of detection information is used to determine confidence score associated with the object. In examples, if the object is a dark color and positioned at an angle such that a small surface of the object is in the line or sight of the LiDAR, the LSN confidence score is updated as the object is positioned to cause low reflected light and the color of the object poorly reflects light. In examples, the LSN trained to output an object spatial location based on LiDAR data, output data of an ISN, and angle information as inputs.

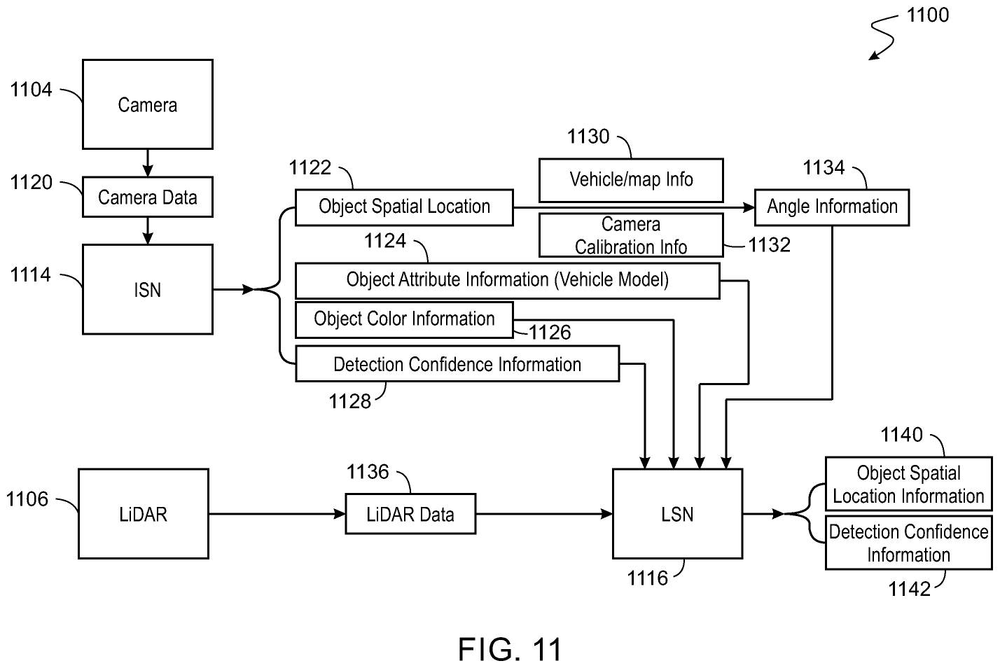

FIG. 11 shows a workflow 1100 for camera assisted LiDAR data verification. In some embodiments, one or more of the steps described with respect to workflow 1100 are performed (e.g., completely, partially, and/or the like) autonomous vehicle (AV) system 114, fleet management system 116 described in FIG. 1, vehicle 200 of FIG. 2, device 300 of FIG. 3, autonomous vehicle compute 400 of FIG. 4, or the AV compute 510 of FIG. 5. In some embodiments, the ISN 1114 is the same as or similar to the ISN 914 of FIG. 9, ISN 814 of FIG. 8, or the ISN 714 of FIG. 7; and the LSN 1116 is the same as or similar to the LSN 916 of FIG. 9, LSN 816 of FIG. 8, of the LSN 716 of FIG. 7.

The ISN 1114 takes as input camera data 1120 from the camera 1104. The output of the ISN 1114 includes object spatial location 1122, object attribute information 1124, object color information 1126, and detection confidence score 1128. The object spatial location 1122, vehicle/map information 1130, and camera calibration information 1132 are used to derive the angle information 1134. In examples, the angle of detection information 1134 is calculated by the angle of a triangle formed the camera location (e.g., extracted from vehicle/map information 1130 and camera calibration information 1132) and the object spatial location 1122.

In some embodiments, the object attribute information 1124 includes a vehicle model. In examples, the object attribute information 1124 includes a material type of the object. In the example where the object is a vehicle, a vehicle model is used. In examples, the vehicle model is a database which stores the 3D vehicle structure information of popular vehicles. In examples, the vehicle model is used for vehicles, i.e., when ISN detects a vehicle in the camera data, the vehicle model information in the database is used to match the vehicle in the camera. When the object is a pedestrian, the object attribute information is not used in LSN.

In the example of FIG. 11, LSN 1116 takes as input LiDAR data 1136 from the LiDAR sensor 1106. The LSN 1116 also takes as input object attribute information 1124, object color information 1126, and detection confidence score 1128, and angle information 1134. The LSN 1116 outputs object spatial location information 1140 and detection confidence score 1142. In embodiments, the LiDAR is trained to determine the confidence score based on LiDAR data, input object attribute information 1124, object color information 1126, detection confidence score 1128, and angle information 1134.

In the example of FIG. 11, information generated from the camera is input to the LSN 1116, and the LSN 1116 uses angle information to determine confidence score associated with the detected object. In examples, when the angle is such that a narrow portion of the object reflects light emitted by the LiDAR, the LSN 1116 outputs a reduced confidence in LiDAR data including the object. When the angle is such that a wider portion of the object reflects light emitted by the LiDAR, a stronger reflectance is observed and the LSN 1116 outputs a higher confidence associated with the LiDAR data including the object. In some embodiments, the present techniques use machine learning to enable the LSN 1116 to determine its own improved confidence score using camera data and angle information. Inputting the ISN 1114 output plus deriving angle information to the LSN 1116 results in a better, more robust LSN 1116 confidence score.

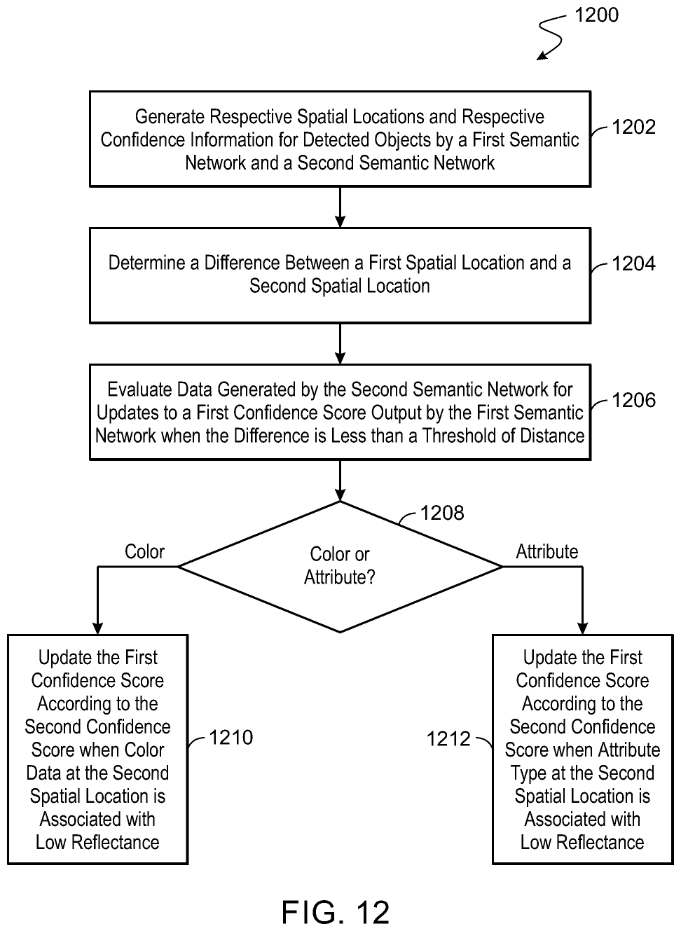

Referring now to FIG. 12, illustrated is a flowchart of a process 1200 for camera assisted LiDAR data verification. In some embodiments, one or more of the steps described with respect to process 1200 are performed (e.g., completely, partially, and/or the like) by autonomous system 202 of FIG. 2. Additionally, or alternatively, in some embodiments one or more steps described with respect to process 1200 are performed (e.g., completely, partially, and/or the like) by another device or group of devices separate from or including autonomous system 202 such as the ISN 1114 or LSN 1116 of FIG. 11, ISN 914 or LSN 916 of FIG. 9, ISN 814 or LSN 816 of FIG. 8, or the ISN 714 or LSN 716 of FIG. 7.

At block 1202, a first semantic segmentation network and a second semantic segmentation network generate respective spatial locations and respective confidence score for detected objects. In an example, the first semantic segmentation network is an LSN, and the second semantic segmentation network is an ISN. In examples, the first semantic segmentation network obtains as input first sensor data (e.g., LIDAR data) and the second semantic segmentation network obtains as input second sensor data (e.g., camera data). The ISN outputs an object spatial location, object color information, object attribute information, and detection confidence score. The LSN outputs object spatial information and detection confidence score.

At block 1204, a difference between a first spatial location (e.g., 3D location from LiDAR) output by the first semantic segmentation network and a second spatial location (e.g., 2D location from camera) output by the second semantic segmentation network is determined. In examples, the first spatial location and the second spatial location are compared to a predetermined threshold.

At block 1206, data generated by the second semantic network is evaluated to determine if updates to a first confidence score output by the first semantic network are made. In some embodiments, data generated by the second semantic network is evaluated when the difference between the spatial locations satisfies a threshold of distance. When data output by the second semantic segmentation network indicates a known low reflectance at the second location, the first confidence score is modified by updating the first confidence score based on the second confidence score. In some embodiments, the updating includes setting the first confidence score equal to the second confidence score. The data output by the second semantic segmentation network includes color data or attribute data. At block 1208, color data or attribute data is selected for evaluation. In some embodiments, both color data and attribute data are selected for evaluation

At block 1210, the first confidence score is updated according to the second confidence score when color data at the second spatial location is associated with low reflectance. In examples, color data is associated with a low reflectance when the color data is within a predetermined threshold of a reference color. At block 1212, the first confidence score is updated according to the second confidence score when attribute type at the second spatial location is associated with low reflectance. In examples, the attribute type is associated with a low reflectance when the attribute type is within a predetermined threshold of a reference attribute.

In some embodiments, an object type is determined based on data output by the first semantic segmentation network and the second semantic segmentation network. Respective sensor data and confidence scores are obtained by an AV stack, and the AV stack performs various functions based on the sensor data and confidence scores. For example, a perception system 402, planning system 404, localization system 406, control system 408, or database 410 (e.g., FIG. 4) obtains the respective sensor data and confidence scores and navigates through an environment (e.g., environment 100) based on the respective sensor data and confidence scores.

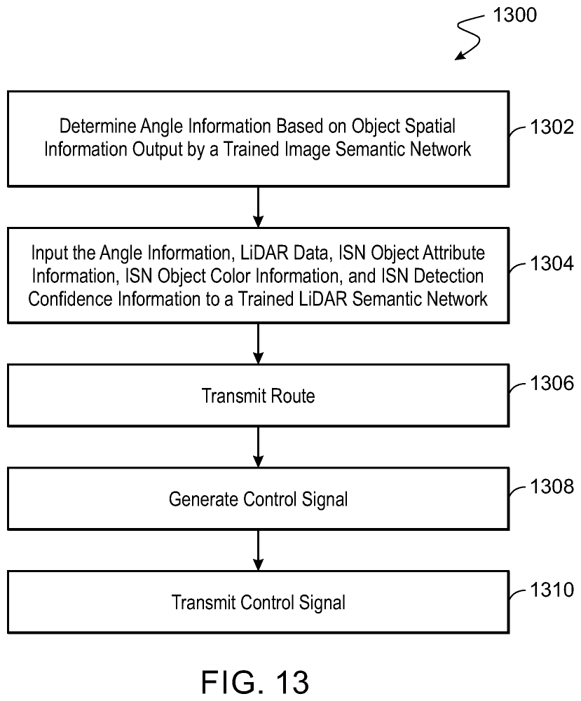

Referring now to FIG. 13, illustrated is a flowchart of a process 1300 for LIDAR semantic network confidence score based on angle information. In some embodiments, one or more of the steps described with respect to process 1300 are performed (e.g., completely, partially, and/or the like) by autonomous system 202 of FIG. 2. Additionally, or alternatively, in some embodiments one or more steps described with respect to process 1300 are performed (e.g., completely, partially, and/or the like) by another device or group of devices separate from or including autonomous system 202 such as the ISN 1114 or LSN 1116 of FIG. 11, ISN 914 or LSN 916 of FIG. 9, ISN 814 or LSN 816 of FIG. 8, or the ISN 714 or LSN 716 of FIG. 7.

At block 1302, output data from a trained image semantic network (ISN) is obtained. In examples, the ISN data include object spatial location, object attribute information, object color information, and detection confidence score 1128. At block 1304, angle information is determined based on object spatial information from the ISN, vehicle information, map information, and calibration information.

At block 1306, LiDAR data, ISN object attribute information, ISN object color information, ISN detection confidence score, and angle information are input to a trained LIDAR semantic network. The trained LiDAR semantic network is trained to output an LSN object spatial information and an LSN confidence score based on the input data.

In examples, the present techniques enable accurate confidence scores associated with LiDAR data. Based on the accurate confidence scores, updating or generating LiDAR data enables the generation of precise images that represent the boundaries of a physical object, the surfaces (e.g., the topology of the surfaces) of the physical object, and/or the like. The updated LiDAR information enables better localization, where a localization system (e.g., localization system 406 of FIG. 4) determines the position of the AV in the area based on comparing updated LiDAR information to a map.

According to some non-limiting embodiments or examples, provided is a system including at least one processor and at least one non-transitory storage media storing instructions. The instructions, when executed by the at least one processor, cause the at least one processor to execute a first semantic segmentation network and a second semantic segmentation network, wherein, when executing, the first semantic segmentation network obtains as input first sensor data and the second semantic segmentation network obtains as input second sensor data. The instructions, when executed by the at least one processor, cause the at least one processor to determine a difference between a first location output by the first semantic segmentation network and a second location output by the second semantic segmentation network. The instructions, when executed by the at least one processor, cause the at least one processor to update a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score. The instructions, when executed by the at least one processor, cause the at least one processor to determine an object type based on data output by the first semantic segmentation network and the second semantic segmentation network.

According to some non-limiting embodiments or examples, provided is a method. The method includes executing, with at least one processor, a first semantic segmentation network and a second semantic segmentation network, wherein, when executing, the first semantic segmentation network obtains as input first sensor data and the second semantic segmentation network obtains as input second sensor data. The method includes determining, with the at least one processor, a difference between a first location output by the first semantic segmentation network and a second location output by the second semantic segmentation network. The method includes updating, with the at least one processor, a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score. The method includes determining, with the at least one processor, an object type based on data output by the first semantic segmentation network and the second semantic segmentation network.

According to some non-limiting embodiments or examples, provided is at least one non-transitory storage media storing instructions. The instructions, when executed by at least one processor, cause the at least one processor to execute a first semantic segmentation network and a second semantic segmentation network, wherein, when executing, the first semantic segmentation network obtains as input first sensor data and the second semantic segmentation network obtains as input second sensor data. The instructions, when executed by at least one processor, cause the at least one processor to determine a difference between a first location output by the first semantic segmentation network and a second location output by the second semantic segmentation network. The instructions, when executed by at least one processor, cause the at least one processor to update a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score. The instructions, when executed by at least one processor, cause the at least one processor to determine an object type based on data output by the first semantic segmentation network and the second semantic segmentation network.

According to some non-limiting embodiments or examples, provided is a system including at least one processor and at least one non-transitory storage media storing instructions. The instructions, when executed by at least one processor, cause the at least one processor to execute a first semantic segmentation network, wherein, when executing, the first semantic segmentation network obtains camera data as input and outputs data associated with a first spatial location of an object, object attribute information associated with the object, object color information associated with the object, and a first detection confidence score associated with the object. The instructions, when executed by at least one processor, cause the at least one processor to determine angle information based on the first spatial location of the object, map information, and camera calibration information. The instructions, when executed by at least one processor, cause the at least one processor to execute a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score. The instructions, when executed by at least one processor, cause the at least one processor to cause a vehicle to be controlled based on the first spatial location, first detection confidence score, second spatial location and second detection confidence score.

According to some non-limiting embodiments or examples, provided is a method. The method includes executing, with at least one processor, a first semantic segmentation network, wherein, when executing, the first semantic segmentation network obtains camera data as input and outputs data associated with a first spatial location of an object, object attribute information associated with the object, object color information associated with the object, and a first detection confidence score associated with the object. The method includes determining, with the at least one processor, angle information based on the first spatial location of the object, map information, and camera calibration information. The method includes executing, with the at least one processor, a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score. The method includes causing, with the at least one processor, a vehicle to be controlled based on the first spatial location, first detection confidence score, second spatial location and second detection confidence score.

According to some non-limiting embodiments or examples, provided is at least one non-transitory storage media storing instructions. The instructions, when executed by at least one processor, cause the at least one processor to execute a first semantic segmentation network, wherein, when executing, the first semantic segmentation network obtains camera data as input and outputs data associated with a first spatial location of an object, object attribute information associated with the object, object color information associated with the object, and a first detection confidence score associated with the object. The instructions, when executed by at least one processor, cause the at least one processor to determine angle information based on the first spatial location of the object, map information, and camera calibration information. The instructions, when executed by at least one processor, cause the at least one processor to execute a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score. The instructions, when executed by at least one processor, cause the at least one processor to cause a vehicle to be controlled based on the first spatial location, first detection confidence score, second spatial location and second detection confidence score.

Further non-limiting aspects or embodiments are set forth in the following numbered clauses:
Clause 1: A system, comprising: at least one processor, and at least one non-transitory storage media storing instructions that, when executed by the at least one processor, cause the at least one processor to: execute a first semantic segmentation network and a second semantic segmentation network, wherein, when executing, the first semantic segmentation network obtains as input first sensor data and the second semantic segmentation network obtains as input second sensor data; determine a difference between a first location output by the first semantic segmentation network and a second location output by the second semantic segmentation network; update a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score; and determine an object type based on data output by the first semantic segmentation network and the second semantic segmentation network.
Clause 2: The system of clause 1, wherein updating the first confidence score comprises setting the first confidence score as equal to a second confidence score output by the second semantic segmentation network.
Clause 3: The system of clauses 1 or 2, wherein the data is color data, further comprising: evaluating the color data by determining a difference between the color data output by the second semantic segmentation network and a reference color data, and updating the first confidence score output by the first semantic segmentation network when the difference between the color data and the reference color data satisfies a second predetermined threshold.
Clause 4: The system of any of clauses 1-3, wherein the data is attribute data, further comprising: evaluating the attribute data by determining a difference between attribute information output by the second semantic segmentation network and a reference attribute information, and updating the first confidence score output by the first semantic segmentation network when the difference between the attribute information and the reference attribute information is less than a third predetermined threshold.
Clause 5: The system of any of clauses 1-4, wherein the first semantic segmentation network is a LiDAR semantic network that generates a first set of bounding boxes associated with objects in the environment, the first set of bounding boxes comprising the first location and the first confidence scores indicating the presence of object class instances within the first set of bounding boxes.
Clause 6: The system of any of clauses 1-5, wherein the second semantic segmentation network is an image semantic network that generates a second set of bounding boxes associated with objects in the environment, the second set of bounding boxes comprising the second location and the second confidence score indicating the presence of object class instances within the second set of bounding boxes.
Clause 7: The system of any of clauses 1-6, wherein the first location output by the first semantic segmentation network is a three-dimensional location, and wherein determining a difference between the first location and the second location comprises projecting the first location onto a two-dimensional surface and comparing the projected first location to the second location.
Clause 8: The system of any of clauses 1-7, wherein a bird's eye view network receives as input the output of the first semantic segmentation network and the second semantic segmentation network, and outputs an indication of a detected object.
Clause 9: The system of any of clauses 1-8, wherein the second semantic segmentation network outputs ambient light information used to detect the object.
Clause 10: The system of clause 3, wherein the reference color is selected to correspond to a color associated with the known low reflectance.
Clause 11: The system of clause 4, wherein the reference attribute is selected to correspond to an attribute type associated with the known low reflectance.
Clause 12: A method, comprising: executing, with at least one processor, a first semantic segmentation network and a second semantic segmentation network, wherein, when executing, the first semantic segmentation network obtains as input first sensor data and the second semantic segmentation network obtains as input second sensor data; determining, with the at least one processor, a difference between a first location output by the first semantic segmentation network and a second location output by the second semantic segmentation network; updating, with the at least one processor, a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score; and determining, with the at least one processor, an object type based on data output by the first semantic segmentation network and the second semantic segmentation network.
Clause 13: The method of clause 12, wherein updating the first confidence score comprises setting the first confidence score as equal to a second confidence score output by the second semantic segmentation network.
Clause 14: The method of clauses 12 or 13, wherein the data is color data, further comprising: evaluating the color data by determining a difference between the color data output by the second semantic segmentation network and a reference color data; and updating the first confidence score output by the first semantic segmentation network when the difference between the color data and the reference color data satisfies a second predetermined threshold.
Clause 15: The method of any of clauses 12-14, wherein the data is attribute data, further comprising: evaluating the attribute data by determining a difference between attribute information output by the second semantic segmentation network and a reference attribute information, and updating the first confidence score output by the first semantic segmentation network when the difference between the attribute information and the reference attribute information is less than a third predetermined threshold.
Clause 16: The method of any of clauses 12-15, wherein the first semantic segmentation network is a LiDAR semantic network that generates a first set of bounding boxes associated with objects in the environment, the first set of bounding boxes comprising the first location and the first confidence scores indicating the
Clause 17: The method of any of clauses 12-16, wherein the second semantic segmentation network is an image semantic network that generates a second set of bounding boxes associated with objects in the environment, the second set of bounding boxes comprising the second location and the second confidence score indicating the presence of object class instances within the second set of bounding boxes.
Clause 18: The method of any of clauses 12-17, wherein the first location output by the first semantic segmentation network is a three-dimensional location, and wherein determining a difference between the first location and the second location comprises projecting the first location onto a two-dimensional surface and comparing the projected first location to the second location.
Clause 19: The method of any of clauses 12-18, wherein a bird's eye view network receives as input the output of the first semantic segmentation network and the second semantic segmentation network, and outputs an indication of a detected object.
Clause 20: The method of any of clauses 12-19, wherein the second semantic segmentation network outputs ambient light information used to detect the object.
Clause 21: The method of clause 14, wherein the reference color is selected to correspond to a color associated with the known low reflectance.
Clause 22: The method of clause 15, wherein the reference attribute is selected to correspond to an attribute type associated with the known low reflectance.
Clause 23: At least one non-transitory storage media storing instructions that, when executed by at least one processor, cause the at least one processor to: execute a first semantic segmentation network and a second semantic segmentation network, wherein, when executing, the first semantic segmentation network obtains as input first sensor data and the second semantic segmentation network obtains as input second sensor data; determine a difference between a first location output by the first semantic segmentation network and a second location output by the second semantic segmentation network; update a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score; and determine an object type based on data output by the first semantic segmentation network and the second semantic segmentation network.
Clause 24: The at least one non-transitory storage media of clause 23, wherein updating the first confidence score comprises setting the first confidence score as equal to a second confidence score output by the second semantic segmentation network.
Clause 25: The at least one non-transitory storage media of clauses 23 or 24, wherein the data is color data, further comprising: evaluating the color data by determining a difference between the color data output by the second semantic segmentation network and a reference color data; and updating the first confidence score output by the first semantic segmentation network when the difference between the color data and the reference color data satisfies a second predetermined threshold.
Clause 26: The at least one non-transitory storage media of any of clauses 23-25, wherein the data is attribute data, further comprising evaluating the attribute data by determining a difference between attribute information output by the second semantic segmentation network and a reference attribute information; and updating the first confidence score output by the first semantic segmentation network when the difference between the attribute information and the reference attribute information is less than a third predetermined threshold.
Clause 27: The at least one non-transitory storage media of any of clauses 23-26, wherein the first semantic segmentation network is a LIDAR semantic network that generates a first set of bounding boxes associated with objects in the environment, the first set of bounding boxes comprising the first location and the first confidence scores indicating the presence of object class instances within the first set of bounding boxes.
Clause 28: The at least one non-transitory storage media of any of clauses 23-27, wherein the second semantic segmentation network is an image semantic network that generates a second set of bounding boxes associated with objects in the environment, the second set of bounding boxes comprising the second location and the second confidence score indicating the presence of object class instances within the second set of bounding boxes.
Clause 29: The at least one non-transitory storage media of any of clauses 23-28, wherein the first location output by the first semantic segmentation network is a three-dimensional location; and wherein determining a difference between the first location and the second location comprises projecting the first location onto a two-dimensional surface and comparing the projected first location to the second location.
Clause 30: The at least one non-transitory storage media of any of clauses 23-29, wherein a bird's eye view network receives as input the output of the first semantic segmentation network and the second semantic segmentation network, and outputs an indication of a detected object.
Clause 31: The at least one non-transitory storage media of any of clauses 23-30, wherein the second semantic segmentation network outputs ambient light information used to detect the object.
Clause 32: The at least one non-transitory storage media of clause 25, wherein the reference color is selected to correspond to a color associated with the known low reflectance.
Clause 33: The at least one non-transitory storage media of clause 26, wherein the reference attribute is selected to correspond to an attribute type associated with the known low reflectance.
Clause 34: A system, comprising: at least one processor, and at least one non-transitory storage media storing instructions that, when executed by the at least one processor, cause the at least one processor to: execute a first semantic segmentation network, wherein, when executing, the first semantic segmentation network obtains camera data as input and outputs data associated with a first spatial location of an object, object attribute information associated with the object, object color information associated with the object, and a first detection confidence score associated with the object; determine angle information based on the first spatial location of the object, map information, and camera calibration information; execute a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score; and cause a vehicle to be controlled based on the first spatial location, first detection confidence score, second spatial location and second detection confidence score.
Clause 35: The system of clause 34, wherein the angle information is determined based on map information and camera calibration information.
Clause 36: The system of clauses 34 or 35, wherein the object attribute information is based on a model associated with an object classification of the object.
Clause 37: The system of any of clauses 34-36, wherein the object color information is red, green, and blue color values of the object as captured in the camera data.
Clause 38: The system of any of clauses 34-37, wherein the object attribute information of the object or the object color information of the object indicates low reflectivity associated with the object.
Clause 39: The system of clause 38, wherein the first detection confidence score associated with the object is more accurate than the second detection confidence score based on low reflectivity associated with the object, and wherein the second semantic segmentation network updates the second detection confidence score based on the first detection confidence score.
Clause 40: The system of any of clauses 34-39, wherein the object is a black vehicle, and the attribute information is based on a vehicle model associated black vehicles.
Clause 41: The system of any of clauses 34-40, wherein the object is a pedestrian in dark clothes and the attribute information is based on a pedestrian model.
Clause 42: A method, comprising: executing, with at least one processor, a first semantic segmentation network, wherein, when executing, the first semantic segmentation network obtains camera data as input and outputs data associated with a first spatial location of an object, object attribute information associated with the object, object color information associated with the object, and a first detection confidence score associated with the object; determining, with the at least one processor, angle information based on the first spatial location of the object, map information, and camera calibration information; executing, with the at least one processor, a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score; and causing, with the at least one processor, a vehicle to be controlled based on the first spatial location, first detection confidence score, second spatial location and second detection confidence score.
Clause 43: The method of clause 42, wherein the angle information is determined based on map information and camera calibration information.
Clause 44: The method of clauses 42 or 43, wherein the object attribute information is based on a model associated with an object classification of the object.
Clause 45: The method of any of clauses 42-44, wherein the object color information is red, green, and blue color values of the object as captured in the camera data.
Clause 46: The method of any of clauses 42-45, wherein the object attribute information of the object or the object color information of the object indicates low reflectivity associated with the object.
Clause 47: The method of clause 46, wherein the first detection confidence score associated with the object is more accurate than the second detection confidence score based on low reflectivity associated with the object, and wherein the second semantic segmentation network updates the second detection confidence score based on the first detection confidence score.
Clause 48: The method of any of clauses 42-47, wherein the object is a black vehicle, and the attribute information is based on a vehicle model associated black vehicles.
Clause 49: The method of any of clauses 42-48, wherein the object is a pedestrian in dark clothes and the attribute information is based on a pedestrian model.
Clause 50: At least one non-transitory storage media storing instructions that, when executed by at least one processor, cause the at least one processor to: execute a first semantic segmentation network, wherein, when executing, the first semantic segmentation network obtains camera data as input and outputs data associated with a first spatial location of an object, object attribute information associated with the object, object color information associated with the object, and a first detection confidence score associated with the object; determine angle information based on the first spatial location of the object, map information, and camera calibration information; execute a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score; and cause a vehicle to be controlled based on the first spatial location, first detection confidence score, second spatial location and second detection confidence score.
Clause 51: The at least one non-transitory storage media of clause 50, wherein the angle information is determined based on map information and camera calibration information.
Clause 52: The at least one non-transitory storage media of clauses 50 or 51, wherein the object attribute information is based on a model associated with an object classification of the object.
Clause 53: The at least one non-transitory storage media of any of clauses 50-52, wherein the object color information is red, green, and blue color values of the object as captured in the camera data.
Clause 54: The at least one non-transitory storage media of any of clauses 50-53, wherein the object attribute information of the object or the object color information of the object indicates low reflectivity associated with the object.
Clause 55: The at least one non-transitory storage media of clause 54, wherein the first detection confidence score associated with the object is more accurate than the second detection confidence score based on low reflectivity associated with the object, and wherein the second semantic segmentation network updates the second detection confidence score based on the first detection confidence score.
Clause 56: The at least one non-transitory storage media of any of clauses 50-55, wherein the object is a black vehicle, and the attribute information is based on a vehicle model associated black vehicles.
Clause 57: The at least one non-transitory storage media of any of clauses 50-56, wherein the object is a pedestrian in dark clothes and the attribute information is based on a pedestrian model.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

What is claimed is:

1. A system, comprising:
at least one processor, and
at least one non-transitory storage media storing instructions that, when executed by the at least one processor, cause the at least one processor to:
execute a first semantic segmentation network and a second semantic segmentation network, wherein, when executing, the first semantic segmentation network obtains as input first sensor data and the second semantic segmentation network obtains as input second sensor data;
determine a difference between a first location output by the first semantic segmentation network and a second location output by the second semantic segmentation network;
update a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score; and
determine an object type based on data output by the first semantic segmentation network and the second semantic segmentation network.

2. The system of claim 1, wherein updating the first confidence score comprises setting the first confidence score as equal to a second confidence score output by the second semantic segmentation network.

3. The system of claim 1 or 2, wherein the data is color data, further comprising:
evaluating the color data by determining a difference between the color data output by the second semantic segmentation network and a reference color data; and
updating the first confidence score output by the first semantic segmentation network when the difference between the color data and the reference color data satisfies a second predetermined threshold.

4. The system of any of claims 1-3, wherein the data is attribute data, further comprising:
evaluating the attribute data by determining a difference between attribute information output by the second semantic segmentation network and a reference attribute information, and
updating the first confidence score output by the first semantic segmentation network when the difference between the attribute information and the reference attribute information is less than a third predetermined threshold.

5. The system of any of claims 1-4, wherein the first semantic segmentation network is a LiDAR semantic network that generates a first set of bounding boxes associated with objects in the environment, the first set of bounding boxes comprising the first location and the first confidence scores indicating the presence of object class instances within the first set of bounding boxes.

6. The system of any of claims 1-5, wherein the second semantic segmentation network is an image semantic network that generates a second set of bounding boxes associated with objects in the environment, the second set of bounding boxes comprising the second location and the second confidence score indicating the presence of object class instances within the second set of bounding boxes.

7. The system of any of claims 1-6, wherein the first location output by the first semantic segmentation network is a three-dimensional location; and
wherein determining a difference between the first location and the second location comprises projecting the first location onto a two-dimensional surface and comparing the projected first location to the second location.

8. The system of any of claims 1-7, wherein a bird's eye view network receives as input the output of the first semantic segmentation network and the second semantic segmentation network, and outputs an indication of a detected object.

9. The system of any of claims 1-8, wherein the second semantic segmentation network outputs ambient light information used to detect the object.

10. The system of claim 3, wherein the reference color is selected to correspond to a color associated with the known low reflectance.

11. The system of claim 4, wherein the reference attribute is selected to correspond to an attribute type associated with the known low reflectance.

12. A method, comprising:
executing, with at least one processor, a first semantic segmentation network and a second semantic segmentation network, wherein, when executing, the first semantic segmentation network obtains as input first sensor data and the second semantic segmentation network obtains as input second sensor data;
determining, with the at least one processor, a difference between a first location output by the first semantic segmentation network and a second location output by the second semantic segmentation network;
updating, with the at least one processor, a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score; and
determining, with the at least one processor, an object type based on data output by the first semantic segmentation network and the second semantic segmentation network.

13. The method of claim 12, wherein updating the first confidence score comprises setting the first confidence score as equal to a second confidence score output by the second semantic segmentation network.

14. The method of claim 12 or 13, wherein the data is color data, further comprising:
evaluating the color data by determining a difference between the color data output by the second semantic segmentation network and a reference color data; and
updating the first confidence score output by the first semantic segmentation network when the difference between the color data and the reference color data satisfies a second predetermined threshold.

15. The method of any of claims 12-14, wherein the data is attribute data, further comprising:
evaluating the attribute data by determining a difference between attribute information output by the second semantic segmentation network and a reference attribute information, and
updating the first confidence score output by the first semantic segmentation network when the difference between the attribute information and the reference attribute information is less than a third predetermined threshold.

16. The method of any of claims 12-15, wherein the first semantic segmentation network is a LIDAR semantic network that generates a first set of bounding boxes associated with objects in the environment, the first set of bounding boxes comprising the first location and the first confidence scores indicating the presence of object class instances within the first set of bounding boxes.

17. The method of any of claims 12-16, wherein the second semantic segmentation network is an image semantic network that generates a second set of bounding boxes associated with objects in the environment, the second set of bounding boxes comprising the second location and the second confidence score indicating the presence of object class instances within the second set of bounding boxes.

18. The method of any of claims 12-17, wherein the first location output by the first semantic segmentation network is a three-dimensional location; and
wherein determining a difference between the first location and the second location comprises projecting the first location onto a two-dimensional surface and comparing the projected first location to the second location.

19. The method of any of claims 12-18, wherein a bird's eye view network receives as input the output of the first semantic segmentation network and the second semantic segmentation network, and outputs an indication of a detected object.

20. The method of any of claims 12-19, wherein the second semantic segmentation network outputs ambient light information used to detect the object.

21. The method of claim 14, wherein the reference color is selected to correspond to a color associated with the known low reflectance.

22. The method of claim 15, wherein the reference attribute is selected to correspond to an attribute type associated with the known low reflectance.

23. At least one non-transitory storage media storing instructions that, when executed by at least one processor, cause the at least one processor to:
execute a first semantic segmentation network and a second semantic segmentation network, wherein, when executing, the first semantic segmentation network obtains as input first sensor data and the second semantic segmentation network obtains as input second sensor data;
determine a difference between a first location output by the first semantic segmentation network and a second location output by the second semantic segmentation network;
update a first confidence score output by the first semantic segmentation network when the difference between the first location and the second location satisfies a first predetermined threshold and data output by the second semantic segmentation indicates a known low reflectance at the second location, wherein the update modifies the first confidence score based on the second confidence score; and
determine an object type based on data output by the first semantic segmentation network and the second semantic segmentation network.

24. The at least one non-transitory storage media of claim 23, wherein updating the first confidence score comprises setting the first confidence score as equal to a second confidence score output by the second semantic segmentation network.

25. The at least one non-transitory storage media of claim 23 or 24, wherein the data is color data, further comprising:
evaluating the color data by determining a difference between the color data output by the second semantic segmentation network and a reference color data; and
updating the first confidence score output by the first semantic segmentation network when the difference between the color data and the reference color data satisfies a second predetermined threshold.

26. The at least one non-transitory storage media of any of claims 23-25, wherein the data is attribute data, further comprising
evaluating the attribute data by determining a difference between attribute information output by the second semantic segmentation network and a reference attribute information; and
updating the first confidence score output by the first semantic segmentation network when the difference between the attribute information and the reference attribute information is less than a third predetermined threshold.

27. The at least one non-transitory storage media of any of claims 23-26, wherein the first semantic segmentation network is a LIDAR semantic network that generates a first set of bounding boxes associated with objects in the environment, the first set of bounding boxes comprising the first location and the first confidence scores indicating the presence of object class instances within the first set of bounding boxes.

28. The at least one non-transitory storage media of any of claims 23-27, wherein the second semantic segmentation network is an image semantic network that generates a second set of bounding boxes associated with objects in the environment, the second set of bounding boxes comprising the second location and the second confidence score indicating the presence of object class instances within the second set of bounding boxes.

29. The at least one non-transitory storage media of any of claims 23-28, wherein the first location output by the first semantic segmentation network is a three-dimensional location; and
wherein determining a difference between the first location and the second location comprises projecting the first location onto a two-dimensional surface and comparing the projected first location to the second location.

30. The at least one non-transitory storage media of any of claims 23-29, wherein a bird's eye view network receives as input the output of the first semantic segmentation network and the second semantic segmentation network, and outputs an indication of a detected object.

31. The at least one non-transitory storage media of any of claims 23-30, wherein the second semantic segmentation network outputs ambient light information used to detect the object.

32. The at least one non-transitory storage media of claim 25, wherein the reference color is selected to correspond to a color associated with the known low reflectance.

33. The at least one non-transitory storage media of claim 26, wherein the reference attribute is selected to correspond to an attribute type associated with the known low reflectance.

34. A system, comprising:
at least one processor, and
at least one non-transitory storage media storing instructions that, when executed by the at least one processor, cause the at least one processor to:
execute a first semantic segmentation network, wherein, when executing, the first semantic segmentation network obtains camera data as input and outputs data associated with a first spatial location of an object, object attribute information associated with the object, object color information associated with the object, and a first detection confidence score associated with the object;
determine angle information based on the first spatial location of the object, map information, and camera calibration information;
execute a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score; and
cause a vehicle to be controlled based on the first spatial location, first detection confidence score, second spatial location and second detection confidence score.

35. The system of claim 34, wherein the angle information is determined based on map information and camera calibration information.

36. The system of claim 34 or 35, wherein the object attribute information is based on a model associated with an object classification of the object.

37. The system of any of claims 34-36, wherein the object color information is red, green, and blue color values of the object as captured in the camera data.

38. The system of any of claims 34-37, wherein the object attribute information of the object or the object color information of the object indicates low reflectivity associated with the object.

39. The system of claim 38, wherein the first detection confidence score associated with the object is more accurate than the second detection confidence score based on low reflectivity associated with the object, and wherein the second semantic segmentation network updates the second detection confidence score based on the first detection confidence score.

40. The system of any of claims 34-39, wherein the object is a black vehicle, and the attribute information is based on a vehicle model associated black vehicles.

41. The system of any of claims 34-40, wherein the object is a pedestrian in dark clothes and the attribute information is based on a pedestrian model.

42. A method, comprising:
executing, with at least one processor, a first semantic segmentation network, wherein, when executing, the first semantic segmentation network obtains camera data as input and outputs data associated with a first spatial location of an object, object attribute information associated with the object, object color information associated with the object, and a first detection confidence score associated with the object;
determining, with the at least one processor, angle information based on the first spatial location of the object, map information, and camera calibration information;
executing, with the at least one processor, a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score; and
causing, with the at least one processor, a vehicle to be controlled based on the first spatial location, first detection confidence score, second spatial location and second detection confidence score.

43. The method of claim 42, wherein the angle information is determined based on map information and camera calibration information.

44. The method of claim 42 or 43, wherein the object attribute information is based on a model associated with an object classification of the object.

45. The method of any of claims 42-44, wherein the object color information is red, green, and blue color values of the object as captured in the camera data.

46. The method of any of claims 42-45, wherein the object attribute information of the object or the object color information of the object indicates low reflectivity associated with the object.

47. The method of claim 46, wherein the first detection confidence score associated with the object is more accurate than the second detection confidence score based on low reflectivity associated with the object, and wherein the second semantic segmentation network updates the second detection confidence score based on the first detection confidence score.

48. The method of any of claims 42-47, wherein the object is a black vehicle, and the attribute information is based on a vehicle model associated black vehicles.

49. The method of any of claims 42-48, wherein the object is a pedestrian in dark clothes and the attribute information is based on a pedestrian model.

50. At least one non-transitory storage media storing instructions that, when executed by at least one processor, cause the at least one processor to:
execute a first semantic segmentation network, wherein, when executing, the first semantic segmentation network obtains camera data as input and outputs data associated with a first spatial location of an object, object attribute information associated with the object, object color information associated with the object, and a first detection confidence score associated with the object;
determine angle information based on the first spatial location of the object, map information, and camera calibration information;
execute a second semantic segmentation network, wherein, when executing, the second semantic segmentation network obtains as input second sensor data, the angle information, the object attribute information, the object color information, and the first detection confidence score, and outputs data associated with a second spatial location and a second detection confidence score; and
cause a vehicle to be controlled based on the first spatial location, first detection confidence score, second spatial location and second detection confidence score.

51. The at least one non-transitory storage media of claim 50, wherein the angle information is determined based on map information and camera calibration information.

52. The at least one non-transitory storage media of claim 50 or 51, wherein the object attribute information is based on a model associated with an object classification of the object.

53. The at least one non-transitory storage media of any of claims 50-52, wherein the object color information is red, green, and blue color values of the object as captured in the camera data.

54. The at least one non-transitory storage media of any of claims 50-53, wherein the object attribute information of the object or the object color information of the object indicates low reflectivity associated with the object.

55. The at least one non-transitory storage media of claim 54, wherein the first detection confidence score associated with the object is more accurate than the second detection confidence score based on low reflectivity associated with the object, and wherein the second semantic segmentation network updates the second detection confidence score based on the first detection confidence score.

56. The at least one non-transitory storage media of any of claims 50-55, wherein the object is a black vehicle, and the attribute information is based on a vehicle model associated black vehicles.

57. The at least one non-transitory storage media of any of claims 50-56, wherein the object is a pedestrian in dark clothes and the attribute information is based on a pedestrian model.
